(19) United States
(12) Patent Application Publication
(10) Pub. No.: US 2023/0222182 A1
(43) Pub. Date: Jul. 13, 2023

(54) UNKNOWN OBJECT CLASSIFICATION FOR UNSUPERVISED SCALABLE AUTO LABELLING

(71) Applicant: Dell Products L.P., Round Rock, TX (US)

(72) Inventors: Vinicius Michel Gottin, Rio de Janeiro (BR); Paulo Abelha Ferreira, Rio de Janeiro (BR)

(21) Appl. No.: 17/647,628

(22) Filed: Jan. 11, 2022

(51) Int. Cl. G06K 9/62; G06N 20/00

(52) U.S. Cl. CPC G06K 9/6277; G06K 9/628; G06K 9/6228; G06K 9/6256; G06N 20/00

(57) ABSTRACT

Classifying unknown samples for scalable automatic labeling are disclosed. Unknown samples are soft labeled at edge nodes. When a node cannot soft label a sample, a candidate node is selected. The candidate node is selected based on why the sample cannot be labelled. The sample is communicated to the candidate node for labeling. If the candidate node is unsuccessful, a different candidate node may be identified to process and label the sample.

### FIELD OF THE INVENTION

Embodiments of the present invention generally relate to machine learning and to classifying unknown objects. More particularly, at least some embodiments of the invention relate to systems, hardware, software, computer-readable media, and methods for unknown object or sample classification and unsupervised auto labelling.

### BACKGROUND

Machine learning models (referred to herein as models) are becoming the norm. Many applications rely on models to generate output (inferences) that can be used for various purposes. Self-driving vehicles, for example, may use models to recognize objects in the vicinity of the vehicle. Cameras on the vehicle may capture images and the images are then classified by the model. However, the ability of a model to generate a useful inference may be limited to the set of classes known by the model. The model, in effect, may not be able to classify some of the images.

In a simple example, a model may be trained to recognize classes such as person, dog, and sign. Each image captured by the vehicle's cameras are classified and inferences may be generated. If image includes an animal other than a dog, the model may not be able to classify the image. If the model is an open set model (one of the classes is, in effect, an unknown class), then the image in this example may be classified as unknown. The inability to effectively classify an image (or other object) should be addressed.

Automatic labelling based on model inferences are generally limited to the set of classes known by the model. This occurs because a model may not be trained with data corresponding to certain classes. Sometimes, the model may not be sufficiently trained for an allegedly known class. The inability to classify an image indicates that the image cannot be properly labeled and may result in incorrect labeling. In fact, images that cannot be classified are often discarded. The present disclosure provides improved systems and methods for automatically classifying and/or labelling data such as images.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a model such as a classifier or an autoencoder;

FIG. 1B discloses aspects of a system that includes a central node and edge nodes that are configured to perform data classification;

FIG. 1C discloses aspects of a classifier operating at a node;

FIG. 1D discloses additional aspects of models including an autoencoder and a classifier;

FIG. 1E discloses aspects of soft labeling data at a central node;

FIG. 2A discloses additional aspects of a node configured to process and classify images;

FIG. 2B discloses aspects of a catalog that identifies classes known by all edge nodes in a system;

FIG. 2C discloses aspects of identifying unknown samples from a data stream;

FIG. 3A discloses aspects of classifying or labeling samples in a computing system;

FIG. 3B discloses aspects of classifying or labeling samples in a computing system and illustrates set notations;

FIG. 3C discloses aspects of selecting a candidate node to label a sample; and

FIG. 4 discloses aspects of a computing device or system.

### DETAILED DESCRIPTION OF SOME EXAMPLE EMBODIMENTS

Embodiments of the present invention generally relate to machine learning and data classification. More particularly, at least some embodiments of the invention relate to systems, hardware, software, computer-readable media, and methods for classifying data or identifying objects of unknown classes in automatic labelling models. Embodiments of the invention are configured to obtain or generate soft labels for samples of interest, orchestrate a soft labelling process across edge nodes, manage and control heterogeneous and open set models, and improve the operation and management of models across edge nodes.

Labeled data is highly used in machine learning but obtaining labels can be costly and difficult. Embodiments of the invention relate to automatically generating labels and advantageously to automatically generating labels in systems with large volumes of data. Computer vision applications, for example, handle large amounts of data. When potentially thousands (if not substantially more) of nodes are being trained and are generating inferences, extensive sets of labeled data are beneficial.

These models often process incoming data streams (e.g., from a camera). Each of the frames is an example of data that may be processed by a model operating at an edge node. The data or each datum of a data stream may be referred to herein as a sample, which may be of different types. Thus, the term sample or data refers to the input or to the data stream received by a node. Each stream may include multiple samples.

An edge node may be configured to receive samples and at least soft label each sample. A soft label, in one example, is a probabilistic distribution across a set of known classes. Thus, each class is associated with a certain probability. A hard label could be generated by associating the sample with the class having the greatest probability (peak of the distribution).

In some examples, it may not be possible to soft label a sample. For example, some samples may be poorly reconstructed or belong to an unknown class. These samples are referred to herein as samples of interest or difficult samples. Conventionally, difficult samples are discarded or flagged for manual labeling. Embodiments of the invention provide a framework that allows difficult samples to be labeled or classified. More specifically, the framework allows the difficult sample to be considered by another node in the system. By way of example only, the framework selects an appropriate node to process the sample based on the sample itself, classes known to the node identifying the difficult sample, and classes known to other nodes in the system. The framework also allows samples to be considered by a more central node if necessary and also allows for manual labeling.

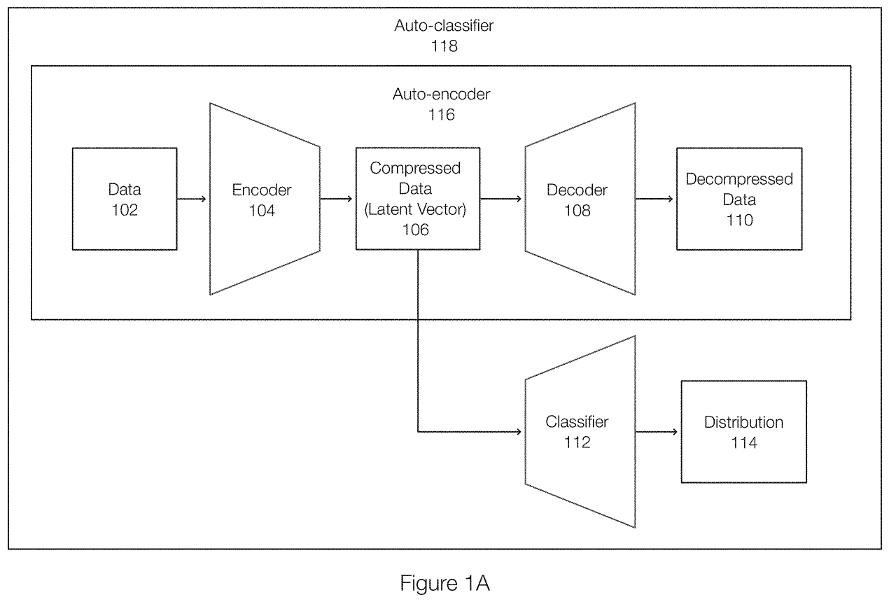

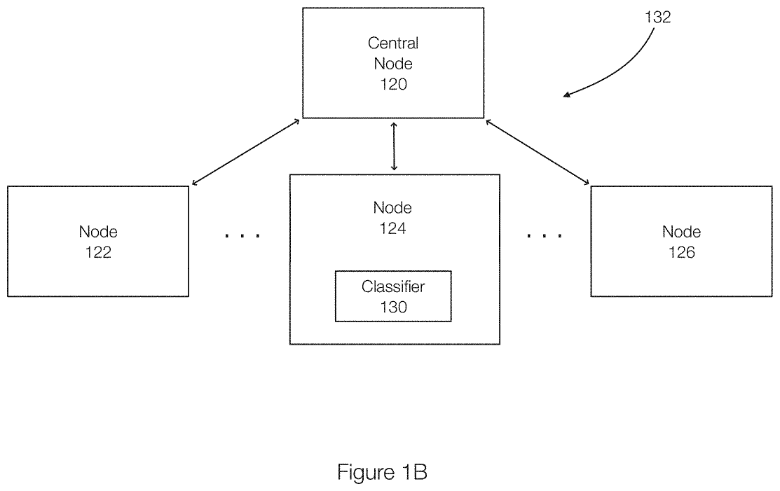

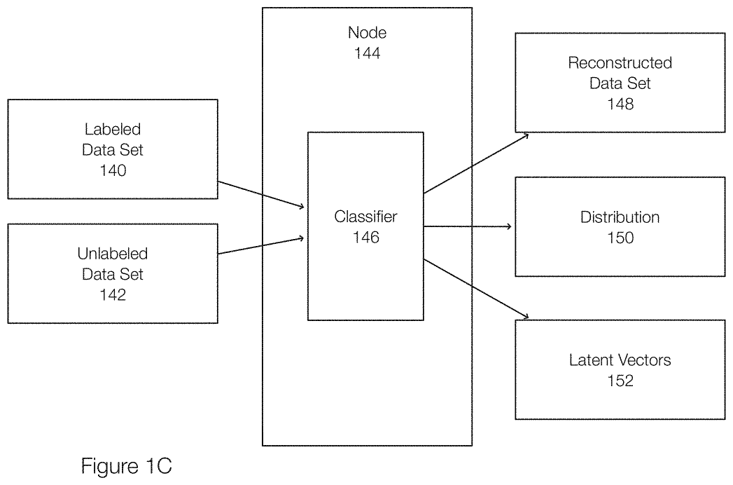

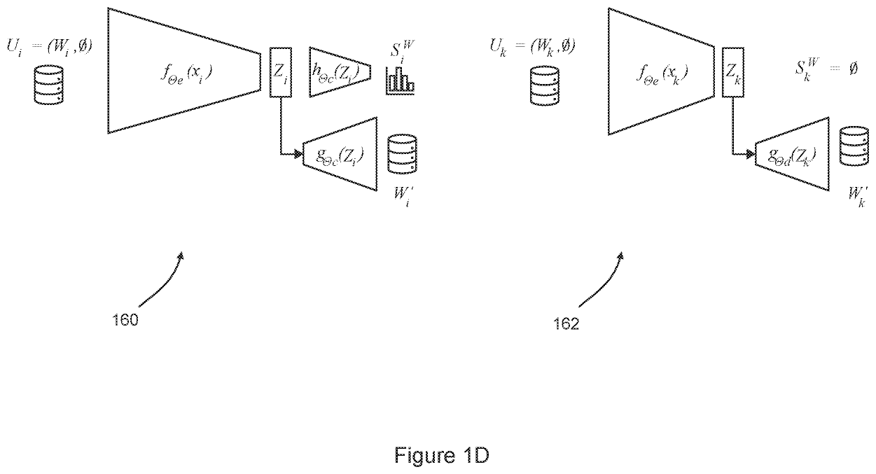

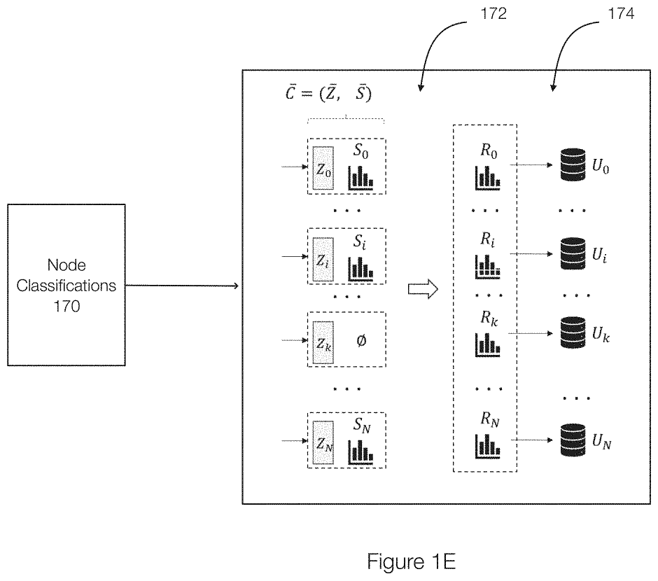

FIG. 1A illustrates discloses aspects of a model configured to compress and decompress high-dimensional data. FIG. 1A more specifically illustrates both an auto-encoder 116 and an auto-classifier 118. Both the auto-encoder 116 and the auto-classifier 118 are examples of models. The auto-classifier 118 is generally an auto-encoder 116 that has been augmented with another model such as a classifier 112. The encoder 104, the decoder 108, and the classifier 112 may be neural networks.

The auto-encoder 116 learns to compress high-dimensional data using an encoder 104 (f_{θ}_{ₑ}(x)) to generate compressed data 106 or a latent vector (z). The compressed data 106 is decompressed using a decoder 108 (g_{θ}_{_{d}}(z)) to generate reconstructed or decompressed data 110.

The auto-encoder 116 may be trained using an appropriate data set that represents a set of classes. The auto-encoder 116 is trained in the same manner in which data is processed, which is by running the training data set through the auto-encoder 116. Once trained, the auto-encoder 116 is configured to receive data 102 for processing. Generally, the auto-encoder 116 is able to determine that a sample is a difficult sample when the reconstructed or decompressed data 110 differs from the data 102 by more than a threshold amount.

The auto-classifier 118 is a modified auto-encoder 116. More specifically, a classifier 112 is added to the auto-encoder. The latent vector (z) 106 generated by the encoder 104 is input to the classifier 112 (h_{θ}_{_{c}}(z)). The classifier 112 generates a probabilistic distribution 114 for the data 102 across the known classes. The probabilistic distribution, in effect, determines (e.g., reflects) the probability of the sample for each class (e.g., the probability that the sample belongs to, or is appropriately classified in, each class). This is an example of soft-labeling a sample.

The auto-classifier 118 is an open set classifier, by way of example only, when the known classes include an unknown class. Thus, samples may be classified as unknown. An open set classifier thus aids in identifying the difficult samples or data. However, embodiments of the invention also provide for identifying or classifying difficult samples identified from models that are not open set models. Classifiers that are not open set classifiers may attempt to fit data into one of the known classes, but this is not optimal. Embodiments of the invention are configured to classify samples (data) that are difficult to classify by orchestrating a process whereby another node can process the same sample. Because other nodes often have a knowledge of a different set of classes, other nodes may be able to label or classify the difficult sample. Further, other nodes may have models that are better at recognizing samples from classes known to the node that identified the difficult sample. In other words, the fact that a node cannot classify or has difficulty classifying a sample does not indicate that the sample does not belong to any of the classes known to that node. Rather, this may only indicate that there was an error or that the model of that node is not sufficiently trained.

One of the reasons for identifying or classifying difficult samples is because of their importance with regard to at least training models. More specifically, difficult samples likely correspond to unknown classes or underrepresented classes. By appropriately classifying difficult samples, the performance of the models can be increased via subsequent training.

FIG. 1B discloses aspects of a computing environment or system for implementing unknown object classification systems and methods. FIG. 1B illustrates a system 132 that includes a central node 120 and edge nodes, represented by nodes 122, 124, and 126. The central node 120 may be a datacenter or a near edge system and typically has more computational resources available for use compared to the nodes 122, 124, and 126. Each of the nodes 122, 124, and 126 includes a processor, memory, and other resources for executing models.

Thus, the central node 120 may be a cloud service with elastic computational resources and each of the nodes 122, 124, and 126 is an edge computing node with sufficient resources to train a small model. In this example, the central node 120 is associated with N edge nodes (N may be very large, e.g., millions). The node 124 includes a classifier 130 (or other model such as an autoencoder). Each of the edge nodes 122, 124, and 126 associated with the central node 120 has at least a classifier and/or an autoencoder. The system 132 is configured to probabilistically label a large dataset of data (e.g., images or other samples) coming from data streams associated with the nodes.

FIG. 1C discloses aspects of training and/or operating a model on a node. Generally, the classifiers that have been distributed to the nodes from the central node are trained using a labeled data set 140 (Dᵢ=(Xᵢ, Yᵢ)). In this example, i is an index to the node or the i^{th} node of N nodes. Dᵢ represents the data set sent to the i^{th} node 144, Xᵢ represents a set of samples (images or other data), and Yᵢ represents the labels associated with the data set. Yᵢ may not be available. However, the node 144 likely includes a classifier if Yᵢ is available and the node 144 likely includes an autoencoder if Yᵢ is not available. Regardless of whether a particular node includes a classifier or an encoder, the following discussion refers to a classifier 146 but it is understood that either may be present.

The classifier 146 is trained and is configured to guarantee consistent boundaries of the latent vectors 152 by normalizing the latent vectors 152 on the same mean and same standard deviation as is performed at all of the edge nodes. Typically, training occurs at the node 144. The nodes are trained on their own data in one example and do not require access to data of other nodes.

The classifier 146 is trained, in one example, to receive a data set and then generate reconstructed data. For example, if the data set includes a datum such as X₁, the classifier 146 is trained to generate a reconstructed datum X. If Yᵢ is available, a distribution 150 (Sᵢ) for the data over the known classes is also generated.

Once trained, the unlabeled data set 142 (Uᵢ=(Wᵢ, Ø)) may be run through the classifier 146. The label portion of the unlabeled data set 142 is empty (Ø). Pairs of latent vectors and distributions are collected or generated for each sample j in the unlabeled data set 142 (Cᵢ^{j}=(Zᵢ^{j}, Sᵢ^{j})). In some examples, such as when the node only includes an autoencoder, the distribution portion of these pairs may be empty (Cᵢ^{j}=(Zᵢ^{j}, Ø)).

Each of the latent vectors (Zᵢ^{j}) represents a compressed version of a corresponding sample and has the same dimensionality as latent vectors generated at other nodes. The predicted distributions (Sᵢ^{j}) for the samples in the unlabeled data set 142 have the same dimensionality. These probabilistic distributions are examples of soft labels and can be converted to hard labels by selecting, by way of example, a peak of the distribution, which corresponds to one of the known classes.

FIG. 1D illustrates an example of the outputs that may be acquired at nodes from an incoming data stream, which is an example of a data set W. In this example, the node 160 is the i^{th} node and the node 162 is the k^{th} node.

For the node 160, the pairs Cᵢ for the data set Wᵢ include the latent vectors Zᵢ and the distributions Sᵢ^{W}. For the node 162, the pairs Cₖ for the data set Wₖ include the latent vectors Zₖ and the distributions Sₖ^{W}.

Each node associated with the central node may transmit its classifications C to the central node. The classifications received from the nodes may be represented as C̅. Thus, the classifications received at the central node from all of the edge nodes are represented, collectively, as C̅=(Z̅, S̅). The central node can perform additional processes to further perform soft labeling and/or hard labeling.

FIG. 1E discloses aspects of processing the set of classification outputs received from the nodes. In FIG. 1E, the classifications C̅ are clustered 172. Clustering can be performed based on the distance (dot products) between latent vectors (e.g., d(zₐ^{b}, z_{c}^{d})= [symbol] zₐ^{b}, z_{c}^{d} [symbol] ). Clustering can also be performed using Gaussian Mixture Models with a Bayesian prior, where the Bayesian prior is S̅.

The result of clustering is a new set of classification outputs Rᵢ for each node. The metadata can be associated to each unlabeled sample j in the form of a vector Rᵢ^{j}. This results in improved soft labeling. The soft labels may be converted to a hard label. For example, this may be achieved by assigning, to each sample, the class label with the highest value in the corresponding element of Rᵢ.

As previously discussed, some of the samples in the data set Uᵢ or unlabeled data set 142 may be difficult to classify. Conventionally, these difficult samples may have been discarded and never classified or received by the central node.

As previously stated, the classifiers or models operating at the nodes often generate a reconstructed sample using auto-encoders. For each sample Wᵢ, a reconstructed sample Wᵢ′ is output from the decoder. The reconstructed sample allows the reconstruction to be assessed. Reconstructions that are insufficient or unreasonable are examples of difficult samples. If the difference between the sample and the reconstructed sample is greater than a threshold, no label (soft or hard) is obtained for that sample.

Embodiments of the invention relate to obtaining or generating soft labels for difficult samples by sending the difficult sample to another node that may be successful in labeling or classifying the sample. Thus, the nodes of the system are evaluated and a node is selected to process the difficult sample. This allows samples to be labeled at the edge rather than in a central location (classification at a central location, however, is not excluded from embodiments of the invention). Orchestrating the nodes to cooperate to identify and label difficult samples will improve the performance of the system. This allows, by way of example, the models to receive additional training and improve their ability to accurately label samples and to generate more accurate inferences.

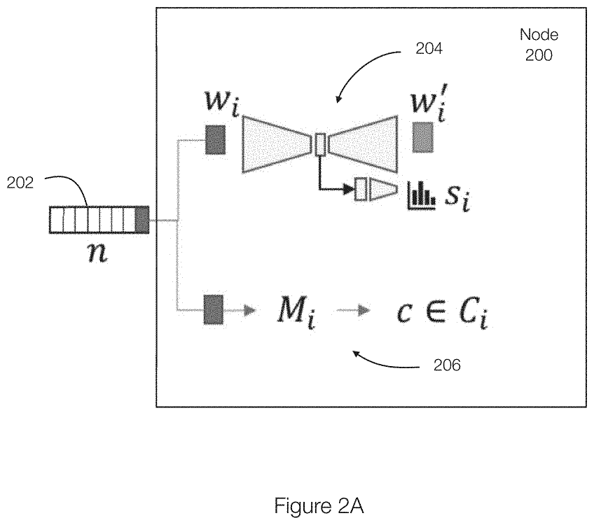

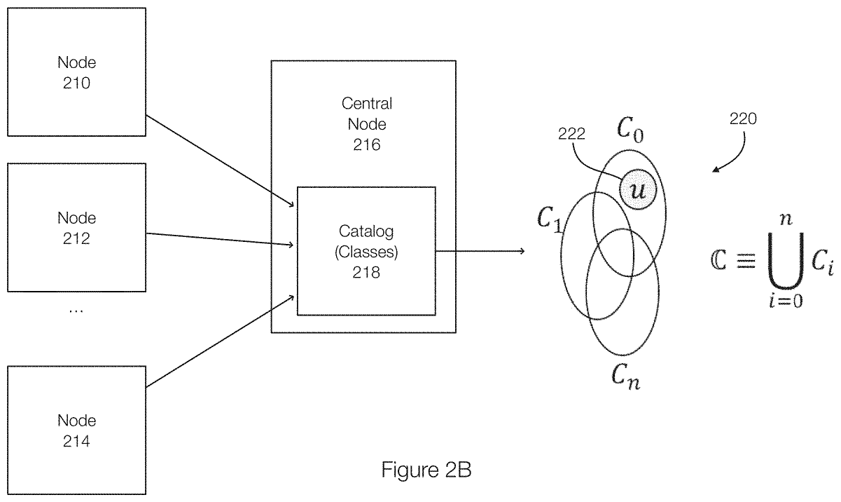

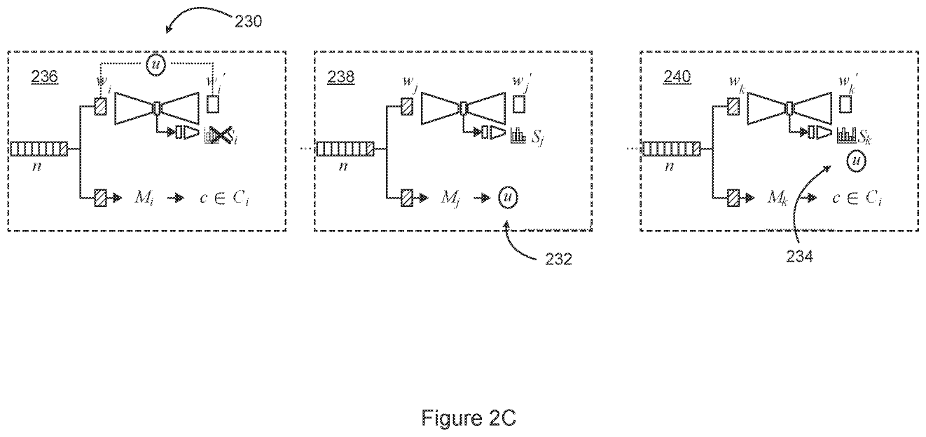

FIG. 2A discloses additional aspects of an edge node that may be associated with a central node. The edge node 200 includes a classifier 204, which is an example of the auto-classifier 118. The node 200 may also include a model 206. The node 200 receives unlabeled data 202, which may include a plurality of samples. Each of the samples may be an image, for example. Each sample wᵢ is processed by the classifier 204, which generates a reconstructed sample wᵢ′ and a distribution Sᵢ. As previously stated, the distribution Sᵢ is a probabilistic distribution associating the sample to the known classes probabilistically. The model Mᵢ 206 may identify a specific class c from the set of known classes Cᵢ.

FIG. 2B discloses aspects of the classes known by each of the edge nodes from the perspective of a central node. In this example, the central node 216 includes a catalog 218 of classes known by the N nodes where N can be between 0 to n, represented by nodes 210, 212, and 214. The catalog 218 is, as illustrated by the Venn diagram 220, a union of the classes known by each specific node (e.g., node 0 through node n). The central node 216 is aware of all classes known by the N nodes. Further, the central node 216 has an understating of the classes known by each node individually.

As previously suggested, some of the models operating on the nodes 210, 212, and 214 may have a known unknown class. Because the unknown class is a known class, the classifier can generate a distribution that also provides a probability that the sample should be classified as unknown. Thus, the class u 222 (the unknown class) is represented in the catalog 218. In addition, the unknown class u 222 of the node 210 is different from the unknown class u of the node 212 and of the node 214. Thus, if the node includes an open set model, the corresponding set of classes for that node may include an unknown class u that is not a member or class in any of the other sets of classes from the other nodes. In other words, each of the unknown classes in the catalog 218 is likely distinct from each other.

As previously stated, embodiments of the invention include the ability to classify (or soft label or hard label) a difficult sample from an unknown class by coordinating with other nodes.

FIG. 2C illustrates examples of identifying difficult samples at the nodes of a computing system. FIG. 2C illustrates nodes 236, 238, and 240, which are the i^{th}, i^{th}, and k^{th} nodes in a computing system. In the node 236, the difficult sample 230 is identified based on the reconstructed sample. More specifically, when the reconstructed sample wᵢ′ differs by more than a threshold amount from the original sample wᵢ, the sample may be a difficult sample. In other words, with regard to the sample wᵢ′, there is a sufficiently large reconstruction error in the output of the autoencoder of the node 236. This suggests that the model does not understand the sample or cannot recognize the sample.

In the node 238, the difficult sample 232 is identified by the domain application model Mⱼ. The difficult sample 232 is classified into the unknown class. In other words, the model Mⱼ is configured to classify samples as unknown when appropriate.

In the node 240, the difficult sample 234 is identified because the distribution Sₖ indicates a highest probability for the unknown class u. The classes over which the distribution is applied includes the unknown class u. When the probability distribution for the sample indicates that the most likely class in the unknown class, the sample may be deemed as a difficult sample.

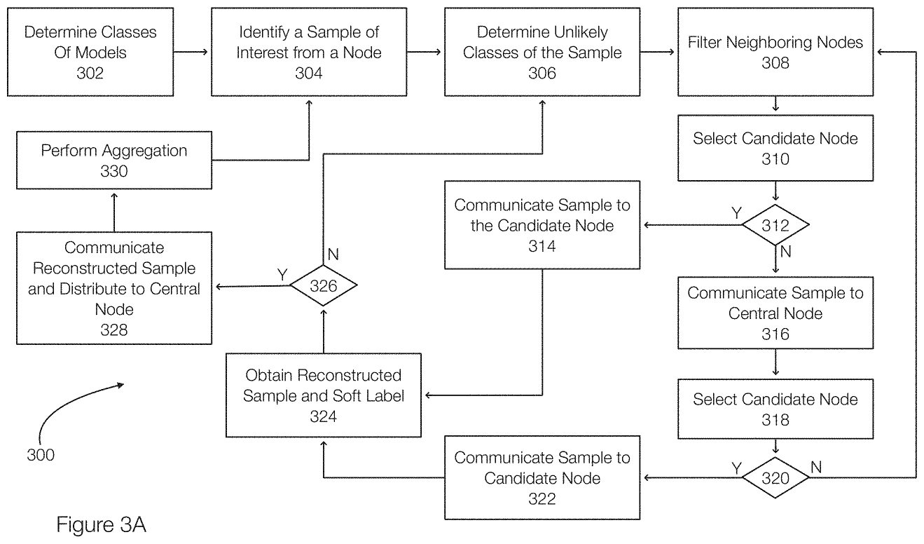

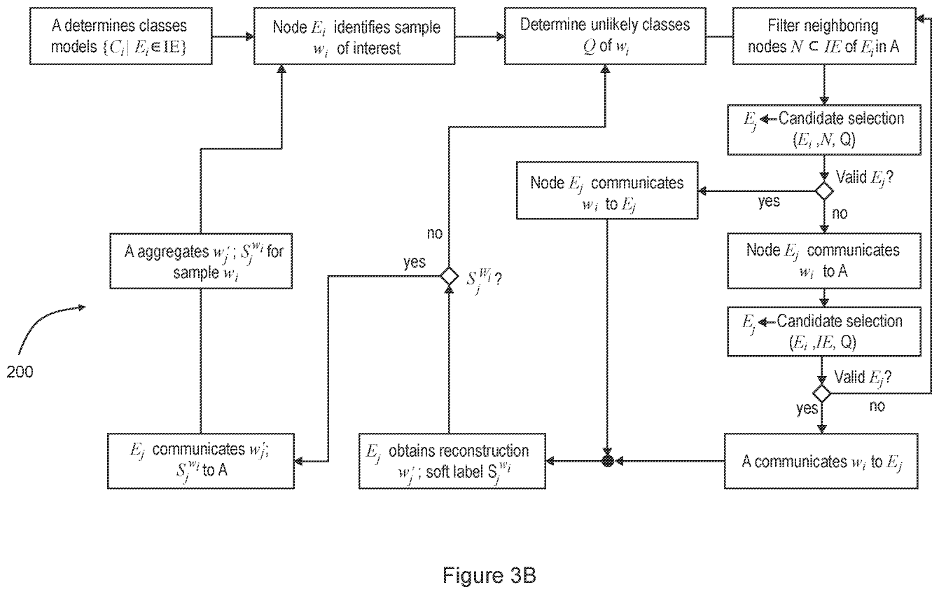

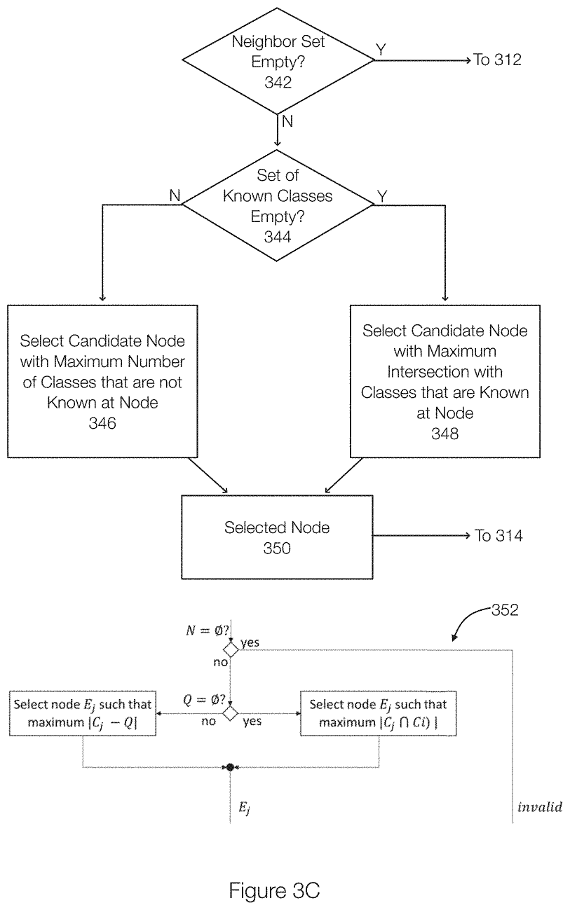

FIG. 3A discloses aspects of classifying unknown samples. More specifically, the method 300 discloses aspects of classifying difficult samples that may be identified at the edge nodes. FIG. 3B illustrates the same aspects of FIG. 3A and further includes mathematical, set, or other notations. The method 300 is configured to identify or provide soft and/or hard labels for the difficult samples identified at the nodes.

More specifically, the method 300 provides the ability to, when possible, use other nodes to classify difficult samples. The method 300 may be performed using the edge nodes and is thus be performed in an edge-based manner, rather than at the central node. The central node, however, may be included in some embodiments.

Some of the elements of the method 300 may be performed a single time or less frequently than other elements of the method 300. For convenience, the method 300 is discussed in terms of a sample. However, the method 300 may be applied to data sets or multiple samples at the same time.

Further, aspects of the method 300 may be performed in a looped manner. For example, assume that a node identifies a sample as a difficult sample. In accordance with the method 300 a candidate node is identified and the difficult sample is sent to that node for labeling. If the candidate node is unsuccessful, the method 300 may loop in order to identify and select another candidate node. Alternatively, the central node may be involved in the process or the difficult sample can be marked for manual labelling.

Initially, classes of models known at the nodes are determined 302. The central node may assemble a catalog of classes known by the nodes collectively. This may be done a single time or periodically. The catalog may be updated, for example, whenever the classes known by the nodes change. This may occur when models, classifiers, or autoencoders at the nodes are updated such that the set of known classes changes.

Next, a sample of interest such as a difficult sample is identified 304 at a node. In this example, the node may identify the difficult sample as previously discussed with reference to FIG. 2C. Once the difficult sample is identified, the unlikely classes of the difficult sample are determined 306. The unlikely classes include the classes that can be excluded from consideration. The set of unlikely classes may depend on the manner in which the difficult sample was identified.

In one example, the set of unlikely classes Q may include all of the classes known by the node at which the difficult sample was identified. For example, if the difficult sample is classified into the unknown class, this indicates that the other classes do not apply to the difficult sample at that node. This is expressed as {c∈Cᵢ|c≠u}. Thus all of the classes known at the node are included in the unlikely classes except for the unknown class u. This may occur in the node 238 shown in FIG. 2C.

Where the sample was identified as a difficult sample based on the probabilistic distribution (see node 234 in FIG. 2C), the unlikely classes may only include those classes known by the node that are below a threshold probabilistic value. The threshold, however, may be defined in a domain specific manner and may be distinct from the threshold used in identifying the difficult sample based on the reconstructed sample wᵢ′.

After the unlikely classes Q have been identified, neighboring nodes are identified 308. The neighboring nodes are identified with respect to the node that identified the difficult sample. Generally, a neighboring node is a node with which the difficult sample can be shared in a reasonable manner. This may depend on latencies, computational costs, transmission costs, whether direct node to node transmission is available, or the like. In some examples, direct communications between edge nodes may not be feasible or possible. In one example, neighboring nodes may be determined by the central node. However, the set of neighboring nodes may be empty.

If possible and if the set of neighboring nodes is not empty, at least one candidate node is selected 310 from the nodes that qualify as neighboring nodes. FIG. 3C discloses aspects of identifying or selecting a candidate node from the neighboring nodes.

FIG. 3C assumes that a neighboring node list or set has been determined (even if empty). Thus, if the set of neighboring nodes is empty (Y at 342), the method continues to 312 in FIG. 3A.

If the neighbor set is not empty (N at 312), a determination is made regarding whether the set of known classes is empty at 344. If there are known unlikely classes—the set of known classes is not empty (N at 344). In this case, the candidate node 350 is identified 346 as the node that has the maximum number of classes that are not known at the node that identified the difficult sample. Thus, if the candidate node is nodeⱼ, then the nodeⱼ was selected because it is associated with a maximum value of |Cⱼ−Q|.

If the information on the set of known classes is empty (Y as 344), then it may be assumed that the difficult sample may belong to one of the classes known to the node that identified the difficult node. In this example, it is possible that the node may have been identified as difficult due to error of the autoencoder. In this case, the candidate node 350 is the nodeⱼ that has a maximum intersection 348 with classes that are known at the nodeᵢ that identified the difficult sample (|Cⱼ∩Cᵢ|). The method 300 then continues at 314 in FIG. 3A. This process of selecting the candidate node is further illustrated at 352 with set notation.

Once the candidate node is identified and selected (Y at 312), the sample is communicated 314 to the candidate node and process using the model at the candidate node.

If a candidate node cannot be identified (N at 312) or if the set of neighboring nodes is empty, the sample is communicated to the central node 316. The central node is able to select 318 a candidate node from the entire set of nodes rather than the set of neighboring nodes. The candidate node is selected 318 from all nodes by the central node in a similar manner as described in FIG. 3C.

If a valid candidate node is selected (Y at 320), the sample is communicated 322 to the sample node identified by the central node. If a candidate node cannot be selected 318 (N at 320), then the method 300 may return to identifying a set of neighboring nodes 308 after a predetermined delay in one example with the expectation that node configurations may be changed or updated. Alternatively, the sample may be discarded or scheduled for a later time or marked for manual classification.

Assuming that a candidate node is selected either from the set of neighboring nodes (Y at 312) or from the set of all nodes (Y at 320), the sample is communicated to the candidate node at 314 or 322, depending on how the candidate node was identified.

The candidate node then runs the difficult sample through its model or models. The candidate node may be able to obtain a sufficient reconstruction and a soft label. The process performed at the candidate node to label and/or classify the difficult sample is similar to the process that identified the difficult sample originally at the original node. Thus, the candidate node may be able to identify or classify the difficult sample in part because the candidate node has classes that are not known by the original node, because the model is better trained, because there was no error, or for other reasons.

However, the candidate node may also determine or identify the same as a difficult sample. In other words, the candidate node may not be able to label or classify the difficult sample. If the candidate node cannot successfully classify or label the difficult sample (N at 326), the process repeats by identifying neighbor nodes for the candidate node, updating the set of unlikely classes, and then repeating the process in order to select a new candidate node. Repeating the process typically results in the selection of a different candidate node at least because of the difference in classes known to each of the nodes that have processed the difficult sample. Further, the set of unlikely classes can be augmented based at least on the classes known to the initial candidate node. The process may be configured to mark the difficult sample for manual labelling after a certain number of attempts.

If the sample is successfully classified (Y at 326) by the candidate node, the sample is communicated 328 to the central node. If the sample was communicated to multiple candidate nodes, each of the candidate nodes may have been successful. The results from all of the candidate nodes may be aggregated 330. This process is performed repeatedly as new samples are identified as difficult samples in the system at the edge nodes.

Embodiments of the invention determine soft and/or hard labels for samples of interest, examples of which include difficult samples. However, embodiments of the invention may also perform a similar process in order to validate the operation of various models rather than classify an unknown or difficult sample or for other reasons. Further, the soft or hard labeling can be performed at the edge nodes. The edge nodes can work together, in conjunction with the central node when necessary, to select an appropriate node to soft label of a sample of interest. The communication of the sample and any related metadata may be coordinated directly or via a central node. This process considers the communication costs and the classes known by the models at the edge nodes.

Embodiments of the invention also work for domains in which the edge nodes consume heterogeneous data streams and allows both open set and auto classifier models to be used in the edge-based soft labeling process.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations, computer vision applications, image processing operations, machine learning model operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, edge node, near-edge node or the like.

Example cloud computing environments, which may or may not be public, include storage environments that may provide functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. These clients or nodes may be configured with models and are able to process incoming data streams. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, VMs, containers, or any combination of these, though no particular device implementation or configuration is required for any embodiment.

As used herein, the term ‘data’ or ‘sample’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, image files, image frames, data streams, and database files, as well as contacts, directories, sub-directories, volumes, and any group of one or more of the foregoing.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: identifying a sample at a node from a data stream received at the node by a model, wherein the sample cannot be soft labeled at the node, determining unlikely classes for the sample, selecting a candidate node based on the unlikely classes, communicating the sample to the candidate node, and performing a soft labeling on the sample at the candidate node.

Embodiment 2. The method of embodiment 1, wherein determining unlikely classes includes, when the node includes an open set model, including all classes known to the node in the unlikely classes.

Embodiment 3. The method of embodiment 1 and/or 2, wherein determining unlikely classes includes, when the node does not include an open set model, excluding classes known to the node from the unlikely classes whose probability is lower than a threshold.

Embodiment 4. The method of embodiments 1, 2, and/or 3, further comprising selecting, as the candidate node, a node that maximizes a number of classes not known to the node.

Embodiment 5. The method of embodiments 1, 2, 3, and/or 4, further comprising selecting the candidate node such that an intersection of classes known to the candidate node and classes known to the node are maximized.

Embodiment 6. The method of embodiments 1, 2, 3, 4, and/or 5, further comprising selecting a plurality of candidate nodes.

Embodiment 7. The method of embodiments 1, 2, 3, 4, 5, and/or 6, further comprising selecting the candidate node from a set of neighboring nodes, wherein each node in the set of neighboring nodes is able to communicate with the node directly.

Embodiment 8. The method of embodiments 1, 2, 3, 4, 5, 6, and/or 7, further comprising communicating the soft labeling of the sample performed at the candidate node to the central node.

Embodiment 9. The method of embodiments 1, 2, 3, 4, 5, 6, 7, and/or 8, further comprising selecting the candidate node by the central node from all nodes when the set of neighboring nodes is empty.

Embodiment 10. The method of embodiments 1, 2, 3, 4, 5, 6, 7, 8, and/or 9, wherein the sample is identified based on a reconstruction error, based on a probabilistic distribution over a set of classes that includes an unknown class, or based on an assignment of a known unknown class to the sample.

Embodiment 11. A method for performing any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

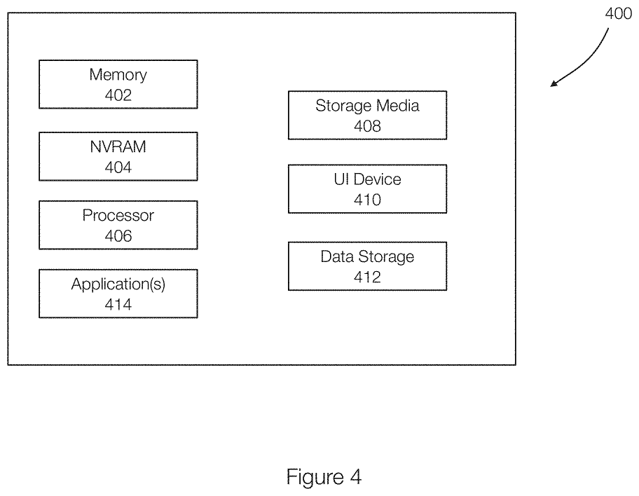

With reference briefly now to FIG. 4, any one or more of the entities disclosed, or implied, by Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including a central node associated with a plurality of nodes, a method, comprising:
identifying a sample at a node from a data stream received at the node by a model, wherein the sample cannot be soft labeled at the node;
determining unlikely classes for the sample;
selecting a candidate node for obtaining a soft label for the sample based on the unlikely classes;
communicating the sample to the candidate node; and
performing a soft labeling on the sample at the candidate node to determine the soft label.

2. The method of claim 1, wherein determining unlikely classes includes, when the node includes an open set model, including all classes known to the node in the unlikely classes.

3. The method of claim 1, wherein determining unlikely classes includes, when the node does not include an open set model, excluding classes known to the node from the unlikely classes whose probability is lower than a threshold.

4. The method of claim 1, further comprising selecting, as the candidate node, a node that maximizes a number of classes not known to the node.

5. The method of claim 1, further comprising selecting the candidate node such that an intersection of classes known to the candidate node and classes known to the node are maximized.

6. The method of claim 1, further comprising:
selecting a plurality of candidate nodes;
communicating the sample to each of the plurality of candidate nodes, wherein each of the plurality of candidate nodes generates a soft label;
aggregating the soft labels into a single soft label for the sample before communicating; and
communicating the single soft label to the central node.

7. The method of claim 1, further comprising selecting the candidate node from a set of neighboring nodes, wherein each node in the set of neighboring nodes is able to communicate with the node directly.

8. The method of claim 1, further comprising communicating the soft labeling of the sample performed at the candidate node to the central node.

9. The method of claim 1, further comprising selecting the candidate node by the central node from all nodes when a set of neighboring nodes is empty.

10. The method of claim 1, wherein the sample is identified based on a reconstruction error, based on a probabilistic distribution over a set of classes that includes an unknown class, or based on an assignment of a known unknown class to the sample.

11. The method of claim 1, further comprising marking the sample for manual labelling after a threshold number of attempts have been attempted to determine the soft label.

12. In a system including a central node associated with a plurality of nodes, a non-transitory storage medium having stored therein instructions that are executable by one or more hardware processors to perform operations comprising:
identifying a sample at a node from a data stream received at the node by a model, wherein the sample cannot be soft labeled at the node;
determining unlikely classes for the sample;
selecting a candidate node for obtaining a soft label for the sample based on the unlikely classes;
communicating the sample to the candidate node; and
performing a soft labeling on the sample at the candidate node to determine the soft label.

13. The non-transitory storage medium of claim 12, wherein determining unlikely classes includes, when the node includes an open set model, including all classes known to the node in the unlikely classes.

14. The non-transitory storage medium of claim 12, wherein determining unlikely classes includes, when the node does not include an open set model, excluding classes known to the node from the unlikely classes whose probability is lower than a threshold.

15. The non-transitory storage medium of claim 12, further comprising selecting, as the candidate node, a node that maximizes a number of classes not known to the node.

16. The non-transitory storage medium of claim 12, further comprising selecting the candidate node such that an intersection of classes known to the candidate node and classes known to the node are maximized.

17. The non-transitory storage medium of claim 12, further comprising:
selecting a plurality of candidate nodes;
communicating the sample to each of the plurality of candidate nodes, wherein each of the plurality of candidate nodes generates a soft label;
aggregating the soft labels into a single soft label for the sample before communicating; and
communicating the single soft label to the central node

18. The non-transitory storage medium of claim 12, further comprising selecting the candidate node from a set of neighboring nodes, wherein each node in the set of neighboring nodes is able to communicate with the node directly.

19. The non-transitory storage medium of claim 12, further comprising communicating the soft labeling of the sample performed at the candidate node to the central node; and selecting the candidate node by the central node from all nodes when a set of neighboring nodes is empty.

20. The non-transitory storage medium of claim 12, wherein the sample is identified based on a reconstruction error, based on a probabilistic distribution over a set of classes that includes an unknown class, or based on an assignment of a known unknown class to the sample.
